(19) United States
(12) Patent Application Publication
(10) Pub. No.: US 2007/0159641 A1
(43) Pub. Date: Jul. 12, 2007

(54) System and method for personalized scented documents

(75) Inventors: Roman D. Liccini, Los Angeles, CA (US); Nishan D. Hossepian, Torrance, CA (US); John M. Gil-Gomez, Rancho Palos Verdes, CA (US); William S. Jacobs, Los Angeles, CA (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/328,885

(22) Filed: Jan. 9, 2006

(51) Int. Cl. G06F 3/12

(52) U.S. Cl. 358/1.1

(57) ABSTRACT

A method for customizing a printed document. The method includes determining the scent application capabilities of a finishing system. If the finishing system can produce a scent, the next step is to determine whether to apply a scent to the document based at least in part upon information associated with the intended recipient of the document. The document is then printed and a scent is applied to the document if it is determined that a scent should be applied to the document. Adding variable scents to variable documents can help increase the power of targeted advertising.

The embodiments disclosed herein are directed to personalized documents and more specifically to generating personalized scented documents.

Personalized documents are known today. Various entities use variable information to generate personalized mailings to addressees based upon a variety of information. Personalized data includes mundane information such as the phone number and address of each recipient, which may be inserted into bills or invoices, for example. Personalized information can also include other information such as buying habits, income level, occupation, etc. Criteria such as these may be used to generate, for example, targeted advertising to be included with bills or invoices sent to the customer.

Current printing systems allow the creation of scented documents in several ways. For example, some finishing devices include the capability of adding scent to a document. Scent technologies include tiny scented packets or capsules affixed to a printed advertisement using adhesives (for example, Label-Scent®, PowdaScent™, MicroDot™, DiscCover®, LiquaTouch®, ScentSeal®, and TrueEssence®), fragrances applied to printed material with a strong, durable, and odorless coating applied over the printed material (for example, Scratch & Sniff, Touch-a-Scent®, and LiquidScent®), and scents embedded within fragrant inks or varnish (for example, Cover Scent® and AromaLaquer™.) However, currently these technologies are being used to support long run fixed documents with a constant repeated scent. Though such scented documents form an interesting extension to more traditional printing systems, they fail to exploit the full potential of scented documents. Suitably employed, varying the scent could constitute an important additional differentiating vector for variable content personalized documents. To help support the production of such documents, one can use an integrated system for the specification, preview, and generation of personalized scented documents.

What is proposed is a system for creating personalized, scented documents such as advertisements. Using customer data, an entity can apply personalized scents to printed content as well as including personal data in that content. The printing system can include any number of print clients, local or remote, a printer, and one or more finishing devices for applying scents. Before submitting the print job to the printer, the local user interface may allow a user to preview the document to be printed. In embodiments, the UI would allow the user to select whether a scent or scents is added to the printed output. The finishing device would then apply scents to the printed output, with variable customer data determining the specific scents to be applied.

The invention includes a printing method for personalizing documents using a single printing apparatus. The method includes the steps of receiving information related to a document to be printed, automatically selecting a scent from a plurality of scents available from a finishing system to apply to the document based at least in part upon the information related to the document, printing the document, and applying the selected scent to the document.

The invention also includes a method for customizing a printed document using a single printing apparatus. The method includes first determining the scent application capabilities of a finishing system. If the finishing system can produce a scent, then the method includes the steps of determining whether to apply a scent to the document based at least in part upon information associated with the intended recipient of the document, printing the document, and applying a scent to the document if it is determined that a scent should be applied to the document.

The invention also includes a method for generating advertisements. The method includes generating a list of recipients, categorizing the recipients into at least two groups based upon information known about the recipients, generating printed advertisements for the list of recipients, and for each group of recipients, applying a particular scent to the advertisements to be sent to the recipients in that group.

The invention also includes a method for generating advertisements. The method includes generating a list of recipients, generate advertisements to be printed containing variable information; printing the advertisements for the list of recipients, selecting a scent to apply to each advertisement based upon the variable information contained therein, and applying at least one of the one or more scents to at least one of the advertisements. The contents of the advertisements are based at least in part on the variable information.

Various exemplary embodiments will be described in detail, with reference to the following figures.

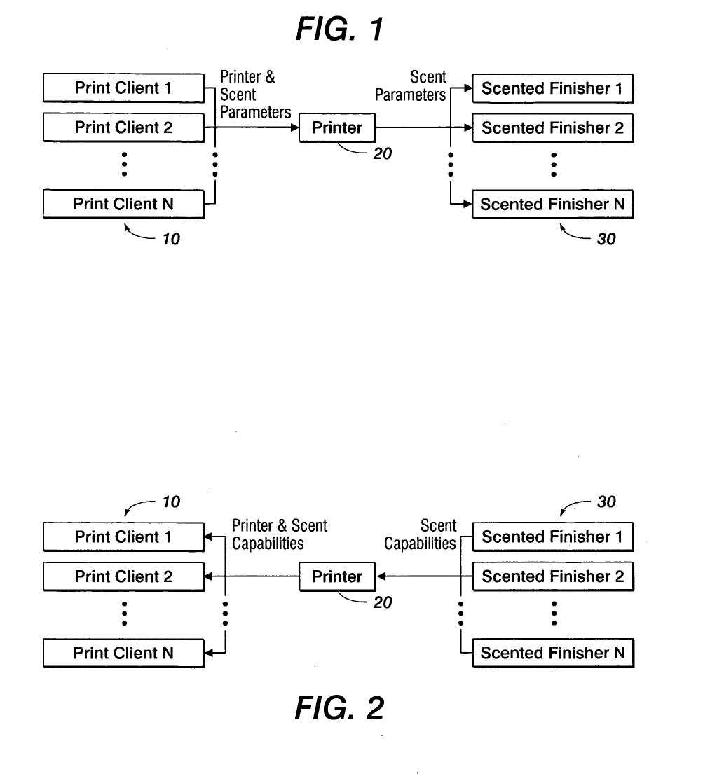

FIGS. 1 and 2 schematically illustrate communication between an array of print clients, a printer, and an array of scented finishers.

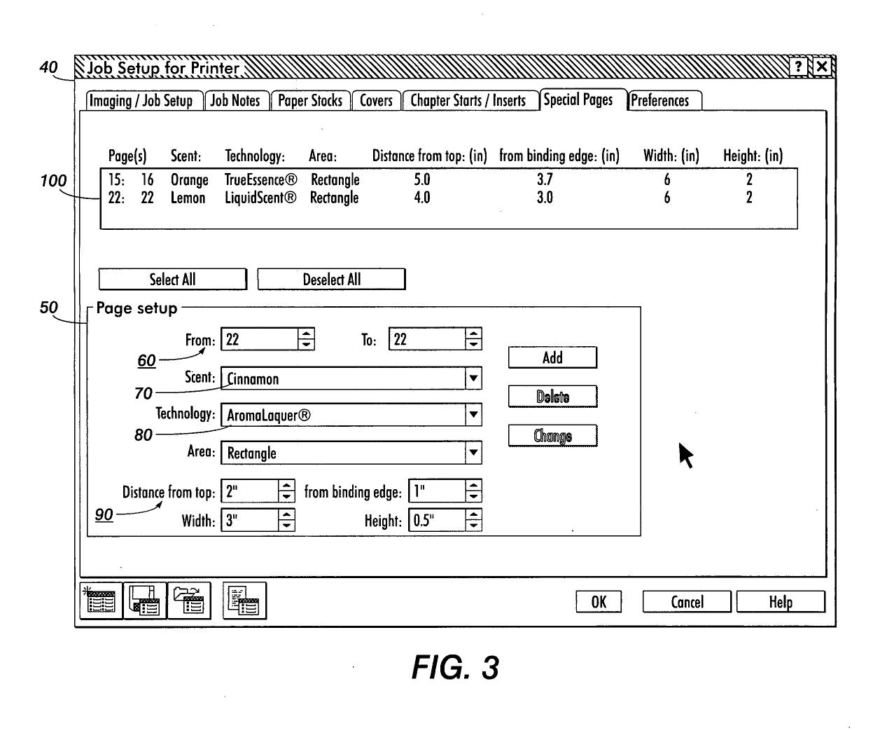

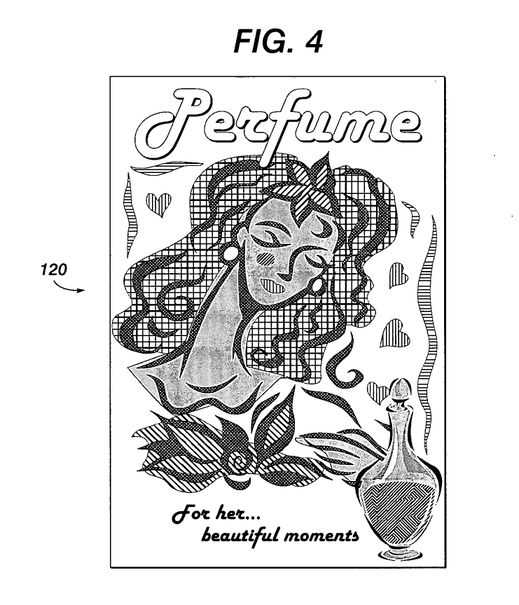

FIG. 3 illustrates an exemplary embodiment of a graphical user interface window that may be used for selectively adding scents to a printed document.

FIG. 4 illustrates a sample advertisement to which a scent may be added.

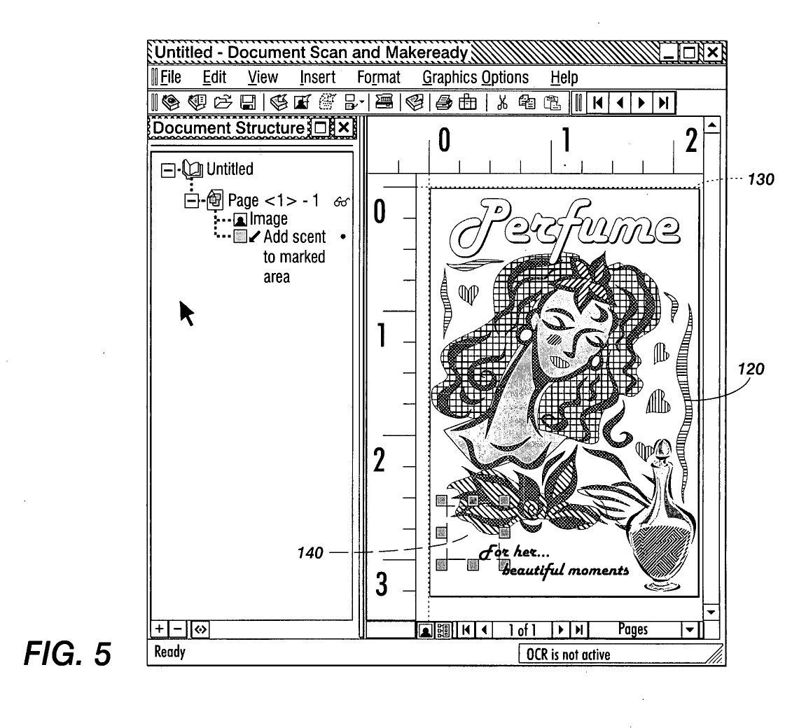

FIG. 5 illustrates another exemplary embodiment of a graphical user interface window, which includes a preview feature for adding a scent to the advertisement of FIG. 4.

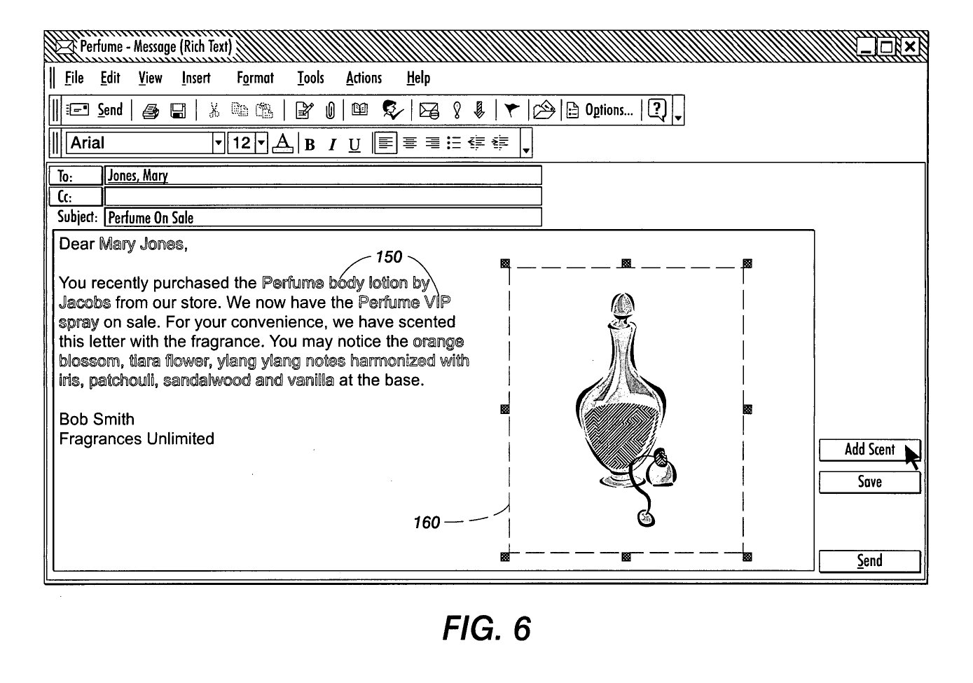

FIG. 6 illustrates a document that includes variable text along with a variable image and scent.

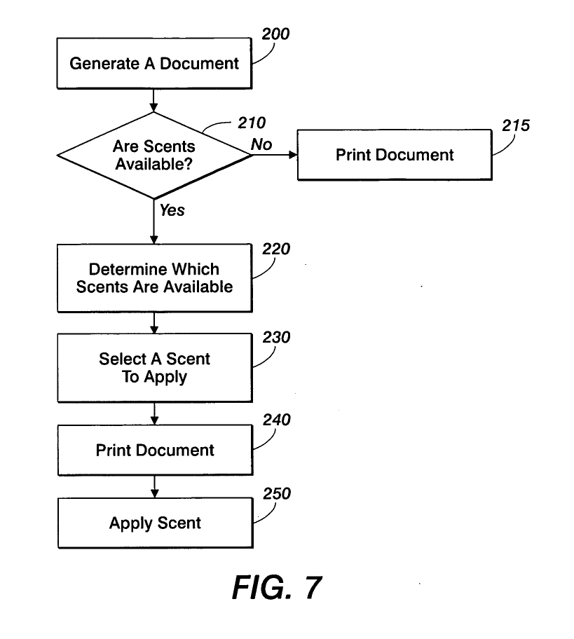

FIG. 7 illustrates a flow chart of an exemplary method for generating a scented document.

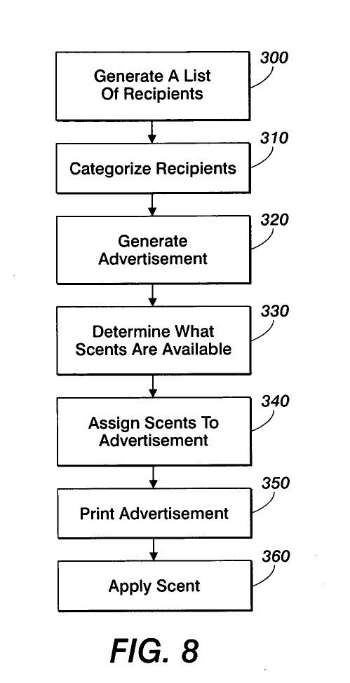

FIG. 8 illustrates a flow chart of an exemplary method for generating targeted advertising using scented documents.

A printing device as used herein refers to any device that produces visible marks on paper. Printing devices include, for example, copiers, printers, or multi-function devices. Paper as used herein refers to any markable media such as, for example, paper, plastic, and textile materials.

A document as referred to herein includes one or more pages of printed paper or pages to be printed.

Typically, a person printing a document defines various qualities of a document to be printed prior to printing, or relies upon a set of default qualities. These qualities include, for example, paper stock, font size, colors and a variety of finishing processes. Documents are typically subjected to a finishing process before being sent to an output tray or area. Most printing apparatuses include a finishing device (or finisher), which may collate, staple, bind, or perform any of a myriad of actions with respect to the document generated. The finisher may be integral with a printing device or it may be a separate device connected in sequence to the printing device. Further multiple finishers may be operably connected to or integral with a print engine. The finisher or finishers may also be physically separate from the printer in some environments such as, for example, a print shop.

FIGS. 1 and 2 illustrate an exemplary printing apparatus arrangement. N print clients 10 are operably connected to a printer 20. The print clients 10 may be in direct local communication with the printer 20 through, for example, a cable, infrared, or radio frequency means. The print clients may also be remote from the printer and connected electronically through, for example, an internet or intranet to the printer 20. In FIGS. 1 and 2, the printer 20 is operably connected to finishers 30. The printer 20 may also be connected to one single finisher 30. The finishers 30 may be a subsystem of the printing device 20, part of a finishing device separate from the printing device 20, or a system of individual devices.

In embodiments, one or more finishers 30 may include scent application capabilities. Someone generating documents could have one of the finishers 30 apply a scent to one or more of the generated documents. Each scented finisher 30 may contain a particular scent different from that of the other scented finishers, or each scented finisher may contain multiple scents. Different finishers 30 may also contain different scent application technologies as well.

FIGS. 1 and 2 illustrate the two-way flow of information between the print clients 10 and the finishers 30. In FIG. 1, a user forwards a completed print job to a finisher capable of applying a selected scent. The scent may be selected by the user or automatically selected based upon information associated with the document. FIG. 2 illustrates an array of finishers 30 sending information regarding their individual scent application capabilities to the array of print clients 10. When a user selects printing and scenting options for a given job, a bidirectional protocol such as, for example, Internet Printing Protocol (IPP) is used to provide the sender with a list of currently available scenting options. The sender then selects from the available options and prints the job. The sender may be the user or may be an automated system or method that may be implemented in software, for example.

Print clients can produce customized mailings based upon recipient information. Customization can include color, fonts, images etc. These can be produced for a variety of purposes. Targeted advertising is one of the most common customization practices. For example, businesses sending out invoices often include advertising intended for the recipient, which advertising could be based upon factors such as, for example, the sex, age, previous buying habits, and/or zip code of the recipient. The advertisement could be a separate or part of a separate sheet or a portion of the invoice itself. Businesses may also send out targeted advertising by itself in the form of flyers, catalogs, etc., which may also be customized. It would be advantageous to increasingly customize mailings by adding custom scents to the documents. Scents can create powerful associations in the mind of the inhaler.

Scents could also be attached to a document for any number of reasons other than advertising. For example, a user may print an image such as a photograph and attach a scent relevant to the background (for example, a pine scent for a pine forest background), or to a person in the image (for example, a cologne or perfume scent worn by the person being imaged). There are also noncommercial mailings such as personal letters to loved ones, political messages, community events, etc. Other uses are envisioned as well.

The system illustrated in FIGS. 1 and 2 enables users to create variable scented documents, particularly customized advertisements. Based upon customer data, the applied scent can be changed. During document design and creation, users will be able to select printing options, scents, areas of application, and scent technology to be used.

FIG. 3 illustrates an exemplary user interface, wherein a user could control which scent should be applied to which pages. The GUI includes a job setup window including a tab 40 for selecting scents to add to a document. The user can identify a page or pages in the page setup area 50 of the special pages section 40. The user identifies a page or pages to be scented input feature 60. The page setup area can also include a scent selection feature 70. The list of available scents may be populated after the system has interrogated all of the known finishing devices for a list of available scents. The page setup area can also include a scent technology selection feature 80. In embodiments, the list of available scent technologies is populated after the system has interrogated all of the known finishing devices connected to a printing device for a list of what scent technologies are available. However, this list could also be customized by the maker or user or otherwise preprogrammed. In embodiments, the user can also select the page area where a scent is to be applied 90. The user can select, for example, to locate the placement of a scent over or near an image on the printed document; e.g., a perfume scent may be associated with an image of a bottle of perfume. Window feature 100 displays the pages to which scents will be added along with information about what scents are to be added, and where on the pages these scents will be added. Pages not listed in this window feature 100 would have no scent added.

The UI shown in FIG. 3 allows the user to add scents to various portions of various pages of a multi-page document. It is one exemplary interface method for adding scents. FIG. 5 shows another interface method for adding a scent to the document shown in FIG. 4. The UI methods of FIGS. 3 and 5 could be alternatives, or they could both be incorporated into the same application or printer UI.

FIG. 4 is an example of a printed document to which a user may wish to attach a scent. Image 120 is an advertisement for a perfume. An advertisement such as that shown in FIG. 4 may not occupy a full sheet, but only a portion of a sheet. To enhance the presentation made by the advertisement, the creator may want to add a scent to the printed output. FIG. 5 illustrates a method for adding that scent.

FIG. 5 illustrates an interface wherein the user can select to add a scent to an image. In FIG. 5, the user can select an area 140 of the image 120, wherein a scent will be located on preview screen 130. Placement of the scent may depend on what scent technology is used. Many scent technologies attach nontransparent packets, capsules, or other materials where the scent is to be located. Preview screen 130 allows the user to locate any scent conveyors so that they do not interfere with any graphics to be printed. The user could simply highlight the area 140 and command that a scent be added there.

In embodiments, a software application could analyze the image(s) and text contained in a document and determine where to apply a scent (or scents) to the document. Software could also be used to select a scent. For example, a program may select customers based on sex, address, age, or prior purchases and assign them to a class. People from different classes would receive different scents dependent upon their class.

Variable scents would most likely be used in conjunction with other variable information. Customer names, addresses, and the names of previously purchased or customer-rated items could all be variable information to be inserted into a document, along with selected odors. FIG. 6 illustrates an example. The highlighted information 150 regarding the customer's name and previous purchases is variable along with the image 160 and scent of the product being advertised.

Sometimes a mailed magazine or catalog may include different items highlighted that are not based upon customer information. For example, a company may make a variety of scented candles. The company may randomly vary which candle the company highlights in its advertisements, or it may vary its selection based on some method that is not based upon the intended recipient's information. In such cases, the scent to be added would be selected based upon which candle was highlighted in the advertisement being sent.

FIG. 7 illustrates an exemplary method for applying scents to documents. First, a document to be printed is generated 200. Next the user or the device determines whether any scents are available to be added to a document 210. If no scents are available, then the document is simply printed without scent 215. If scents are available then the next step is to determine what scents are available 220. If one or more scents are available, application or device software can automatically retrieve which scents are available. The application or user can also query the finisher to determine what scents, if any, are available. A scent is then selected to apply to the document 230. Selecting a scent can include selecting no scent for at least one document. Next, the document is printed 240 and a selected scent is applied to the document 250. These steps may be performed consecutively or simultaneously. As scent applicators are generally located in finishing systems, the document will usually be printed before a scent will be added.

FIG. 8 illustrates an exemplary method for producing targeted advertising. The method includes first generating a list of recipients 300. These may be current customers, past customers, or prospective customers. Each customer profile is variable information. Customer profiles include personal attributes such as, for example, name, address, age, sex, etc. It may also contain information on past purchases or other behavioral information. In embodiments, the intended recipients are then categorized into groups 310. This categorization may be based upon the personal attributes of the intended recipient, the past purchases of the intended recipient, or both. Next, an advertisement is generated 320. This step may be performed before or after steps 300 and 310. However, the advertisement may contain variable image or text data, in which case step 320 will be performed in many cases after steps 300 and 310. However, differentiation in the advertisements may be random or otherwise not based upon the information of the intended recipient. Next, the user or device determines which scents are available to be added to the advertisements 330. Next, each advertisement is assigned one of the available scents 340. This can be based upon the variable information of the recipient or the variable information in the advertisement. Finally, the advertisements are printed 350 and their assigned scents are applied 360. Steps 350 and 360 may be consecutive or simultaneous.

While the present invention has been described with reference to specific embodiments thereof, it will be understood that it is not intended to limit the invention to these embodiments. It is intended to encompass alternatives, modifications, and equivalents, including substantial equivalents, similar equivalents, and the like, as may be included within the spirit and scope of the invention. All patent applications, patents and other publications cited herein are incorporated by reference in their entirety.

1. A printing method for personalizing documents using a single printing:
apparatus, the method comprising:
receiving information related to a document to be printed;
automatically selecting a scent from a plurality of scents available from a finishing system to apply to the document based at least in part upon the information related to the document;
printing the document; and
applying the selected scent to the document.

2. The method of claim 1, wherein the information associated with the document is information related to the intended recipient.

3. The method of claim 1, wherein the information associated with the document is information related to the content of the document.

4. The method of claim 1, further comprising determining what scents make up the plurality of scents.

5. The method of claim 1, wherein printing the document includes printing variable information in the document.

6. The method of claim 5, wherein printing variable information in the document includes printing variable text.

7. The method of claim 5, wherein printing variable information includes printing variable images.

8. A method for customizing a printed document using a single printing apparatus, the method comprising:
determining the scent application capabilities of a finishing system;
determining whether to apply a scent to the document based at least in part upon information associated with the intended recipient of the document;
printing the document; and
applying a scent to the document if it is determined that a scent should be applied to the document.

9. The method of claim 8, wherein determining the scent application capabilities of the finishing system includes receiving scent application capability information from the finishing system.

10. The method of claim 9, further comprising wherein determining the scent application capabilities of the finishing system includes querying the finishing system regarding its scent application capabilities.

11. The method of claim 8, wherein the finishing system includes a plurality of scents that may be applied and further comprising
determining which scent should be applied to the document based at least in part upon the intended recipient of the document.

12. The method of claim 8, wherein the finishing system includes a plurality of scents that may be applied and further comprising
determining which scent should be applied to the document based at least in part upon the content of the document.

13. The method of claim 8, wherein the finishing system includes multiple finishing devices.

14. An apparatus, comprising
a printing device,
a finishing system,
wherein the finishing system contains a plurality of scents that may be applied to a document, and
wherein the scents to be applied are chosen based upon variable information.

15. The apparatus of claim 14, wherein the finishing system is a finishing device distinct from and operably connected to the printing device.

16. The apparatus of claim 14, wherein the finishing system is an integral component of the printing device.

17. A method for generating advertisements, comprising:
generating a list of recipients;
categorizing the recipients into at least two groups based upon information known about the recipients;
generating printed advertisements for the list of recipients; and
for each group of recipients, applying a particular scent to the advertisements to be sent to the recipients in that group.

18. The method of claim 17, wherein the recipient information includes customer attributes.

19. The method of claim 17, wherein the recipient information includes past purchases by the customer.

20. A method for generating advertisements, comprising:
generating a list of recipients;
generating advertisements to be printed containing variable information;
printing the advertisements for the list of recipients,
wherein the contents of the advertisements are based at least in part on the variable information;
selecting a scent to apply to each advertisement based upon the variable information contained therein; and
applying at least one of the one or more scents to at least one of the advertisements.
